(19) United States
(12) Patent Application Publication
(10) Pub. No.: US 2008/0189082 A1
(43) Pub. Date: Aug. 7, 2008

(54) AUTOMATED MICROWAVE NETWORK PLANNER

(75) Inventors: Alan Denis MacDonald, Bellevue, WA (US); Philip Godrick Wystan Woods, Seattle, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: TELECOM TRANSPORT MANAGEMENT INC., Seattle, WA (US)

(21) Appl. No.: 12/026,459

(22) Filed: Feb. 5, 2008

Related U.S. Application Data
(60) Provisional application No. 60/888,126, filed on Feb. 5, 2007.

(51) Int. Cl. G06F 17/50; G06G 7/62

(52) U.S. Cl. 703/1; 703/13

(57) ABSTRACT

A microwave network planner tool (40). The network planner tool (40) allows a user to set parameters for a network design, and to assign weighted values to multiple components of the design of the network. Weighting may be biased to proximity and/or site factors. Executing the tool provides an optimized network designed to constraints defined by the user. For example, if the designer wishes to reduce network cost, the designer may set constraints to the number of links allowed, and may increase the weighting on a selection of preferred location (e.g., a tower with favorable lease conditions).

### REFERENCE TO RELATED APPLICATION

This patent application claims priority to U.S. provisional patent application Ser. No. 60/888,126, filed Feb. 5, 2007, and incorporated herein by reference.

### BACKGROUND OF THE INVENTION

Transport networks are provided by telecommunication firms to wireless carrier customers. The transport networks provide connectivity between carriers' cell site locations and their switching centers. The transport network may use a variety of different types of equipment and/or networks, including microwave.

For example, as shown in FIG. 1, a microwave transport network 20 is provided for connecting to a mobile switching center 22. The mobile switching center 22 is connected to a fiber network 24. A fiber access point 26 is provided on the fiber network 24.

In the network shown in the drawings, a microwave hub 28 is connected to the fiber access point 26 via a microwave link 30. The microwave hub 28 also serves as a cell site. Other cell sites 32 are connected to the microwave hub 28 via microwave links 34.

Traditional design of microwave networks is a labor intensive iterative process. For example, first a selection of sites that require microwave connectivity is made as well as a selection of all other sites that might be necessary to support that network. Then an iterative cycle is entered in which the designer selects point-to-point links that will constitute the entire network. The process is interactive in that the point-to-point links need to be individually designed and confirmed for line of sight and capacity validity. Links that don't work are deleted, and the network is then adjusted, and this adjustment often causes other links to fail design constraints. During this process, the designer also needs to include further design dimensions such as the need for link reliability and capacity versus the selection of lowest cost equipment, versus a site lease cost, versus site implementation complexity, versus connectivity to sites with the greatest revenue opportunities.

The traditional process contains several challenges. Depending on the skill of the designer, and the bias they apply to each of the design dimensions, the resulting microwave network design will most likely be sub-optimal. The iterative and multi-dimensional aspect of the design process makes for a long design cycle, and low productivity. Moreover, management can not easily determine how each design dimension was weighted, and as such cannot determine whether a design is near optimal.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description of some embodiments that are presented later.

In accordance with an embodiment, a microwave network planner tool is provided. The network planner tool allows a user to set parameters for the network design, and to assign weighted values to multiple components of the design of the network. Weighting may be biased to proximity and/or site factors. Executing the tool provides an optimized network designed to the constraints defined by the user. For example, if the designer wishes to reduce network cost, the designer may set constraints to the number of links allowed, and may increase the weighting on a selection of preferred location (e.g., a tower with favorable lease conditions).

In an initial step, a user defines the overall network design constraints, such as the maximum number of links and hops allowed per site, and the starting location. In a second step, available sites in a geographic area are entered, and a terrain model that covers the same geographic area. With each site is provided location information, structure type, and size information. The structure type may include site weighting information, which allows a user to apply a favorability factor for each site for tower weighting, owner weighting, and carrier weighting. These factors affect implementation complexity, operational expense, and possible revenues.

After all information is entered, the tool is executed to select a tier of sites with defined link constraints. The tool utilizes the weighting from site weighting and a proximity weighting that is applied by the user to yield the most favorable tier of sites. The process may be repeated for additional tiers as needed.

Other features of the invention will become apparent from the following detailed description when taken in conjunction with the drawings, in which:

### BRIEF DESCRIPTION OF THE DRAWINGS

FIG. 1 shows a prior art network hub system;

FIG. 2 is a diagrammatic representation of a microwave network planning tool and associated components in accordance with an embodiment;

FIG. 3 is a block diagram representing site information that may be considered by the microwave network planner tool of FIG. 2 in accordance with an embodiment;

FIG. 4 is a diagrammatic representation of a possible way to evaluate proximity information for formation of a microwave network in accordance with an embodiment;

FIG. 5 is a block diagram representing structure type information that may be considered by the microwave network planning tool of FIG. 3 in accordance with an embodiment;

FIG. 6 is a diagrammatic representation of a tree height assumption tool that may be utilized by the microwave network planning tool in accordance with an embodiment;

FIG. 7 is a diagrammatic representation of a blockage rule that may be utilized in accordance with an embodiment;

FIG. 8 shows a flow chart representing steps for preparing the microwave network planner tool to initialize a network planning session in accordance with an embodiment;

FIG. 9 is a representation of a user interface for selecting session parameters in accordance with an embodiment;

FIG. 10 shows a user interface for selecting predefined parameters by a user for the microwave network planning tool in accordance with an embodiment;

FIG. 11 shows steps for a session run by the microwave network planner tool in accordance with an embodiment;

FIG. 12 shows a plot of available sites that may be utilized by the microwave network planner tool in accordance with an example; and

FIG. 13 shows a diagram representing viable links from the map of FIG. 12 in accordance with an embodiment.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described. In addition, to the extent that orientations of the embodiments are described, such as “top,” “bottom,” “front,” “rear,” “right,” and the like, the orientations are to aid the reader in understanding the embodiment being described, and are not meant to be limiting.

Referring now to the drawings, in which like reference numerals represent like parts throughout the several views, FIG. 2 shows a network planning tool 40 that utilizes terrain information 42, site information 44, and network design options 48 to design a microwave network. The designed microwave network may be displayed on a network display 52, or may be provided to a user in another format, such as tabular.

The terrain information 42 is a terrain model for the underlying geography of the area being considered. In an embodiment, the terrain information is in the form of a digital elevation model (DEM). Terrain data may be acquired, for example, via the USGS seamless data website (HTTP://seamless.usgs.gov/).

The site information 44 represents specific information regarding microwave transmitter/receiver sites. In an embodiment, as shown in FIG. 3, the site information 44 includes location information 60, structure type 62, and size information 64. Tree height information 65 may also be stored with the site information 44, or it may be stored with terrain information 42 or in another location. The function of the tree height information 65 is described below.

The location information 60 represents a location of a particular cell tower. The information may be maintained, for example, as latitude and longitude coordinates of the tower.

The structure type 62 represents different factors that may be weighted by a user as being more or less important when designing the microwave network. In the embodiment shown in FIG. 5, there are three factors, but more or less than three may be considered. In FIG. 5, these factors are tower weighting 74, owner weighting 76, and carrier weighting 78. The tower weighting 74 is a cost driver and represents the operational expense and implementation complexity of utilizing the particular cell site. This component and the other components may be combined as a single weighting factor, or each may be separated into multiple components. The owner weighting 76 is also a cost driver and represents who owns the site. The carrier weighting 78 represents who is actually using the site and is a revenue driver (i.e., possible revenues may be associated with the site.)

The size information 64 is information regarding the available heights at which microwave antennas may be installed at the site. This information may include a height assumption, or may include site survey information, or some other type of height factor or variable.

A user may select the importance of each of the factors 74, 76, 78 utilizing a site weighting user interface 46 (FIG. 2).

The network design options 48 includes different options for creating the network. These design options include, but are not limited to, the capacity of the network, how close cell towers may be to one another, the number of links allowed per cell tower, the number of hops (i.e., the number of links between two points), and so forth.

In addition to site weighting, the microwave network planner tool 40 may take into account proximity weighting. That is, the distance between two sites may be taken into account when choosing a network. One way to assign such weighting is to show a preference for sites that are within a defined distance. For example, as shown in FIG. 4, a central hub defines a radius R₁ in which is a number of possible sites 66₁, 66₂, . . . 66_{M}. Within a larger radius R₂, there are a number of sites 68₁, 68₂, . . . 68_{N}. Outside of the radius R₂ are a number of sites 70₁, 70₂, . . . 70_{P}. For such a model, a stronger preference would be given to those sites 66 within R₁, a medium preference would be given to those sites 68 within R₂ but not within R₁, and lower or no preference would be given to those sites 70 outside of R₂.

In an embodiment, preference is provided by assigning a number for each of the distances. For example, for the sites in FIG. 4, the sites in each area are given a number value, such as 4 for the sites 66, 2 for the sites 68 and 0 for the sites 70. Similarly, for the site weighting described above, the weighting for a number of different factors such as the tower weight, owner weight, and carrier weight may be supplied by a user by supplying a number, the range of which may be defined, with the highest number being the most desired. Of course, different methods could be used, and most desired could represent a lower number. For ease of description, however, an embodiment described herein will assume a higher number is more preferred.

In addition to site and proximity information, line of site (LOS) information is relevant to whether or not a microwave link may be formed between two sites. Line of site information is information regarding whether or not a direct line of site may be formed between the two sites. Often, trees or other structures may block use of two towers.

To offset the possibility of trees preventing a line of site connection, in accordance with an embodiment, the microwave network planner tool 40 utilizes the terrain information 42 between two sites. For example, as shown in FIG. 6, terrain information 42 for an area between two towers 80, 82 provides a contour 84 of the land between two towers 80 and 82. Assuming a site buffer 88 (i.e., an area around the towers 80, 82 where there are assumed to be no trees), the microwave network planner tool 40 projects a tree height assumption 86. This height represents a hypothetical tree height for the area between the two towers and outside the buffers 88. This tree height may be based upon known knowledge of the area, an average tree height for the area, a known tree variety in the area and its maximum height, or other information. In any event, the tree height assumption 86 is a conservative estimate of a maximum tree height of trees in the area. After the tree height assumption 86 is applied, a line 90 is drawn between the maximum height at which a microwave antenna can be installed at each of the sites 80, 82. If the line 90 extends above the tree height assumption 86, then the microwave network planner tool 40 assumes that line of site is available between the two towers 80, 82.

To prevent other interference, other factors may be used. For example, the microwave network planning tool 40 may require a particular distance between two sites in the network, such as one mile. As another example, as shown in FIG. 7, for a link 100 to be formed between two sites 102, 104, then no sites may be used that are between the two sites and within an angle ø projected from the original site 104. For example, as shown in FIG. 7, a starting point for an analysis for the addition of a link is the site 104. To add a link 100 connecting the site 104 to the site 102, no sites may be present within the area abounded by the angle ø and between the two sites 104, 102. If a site is in this area, then formation of the link 100 is not permitted, through a policy called “blockage” in this document.

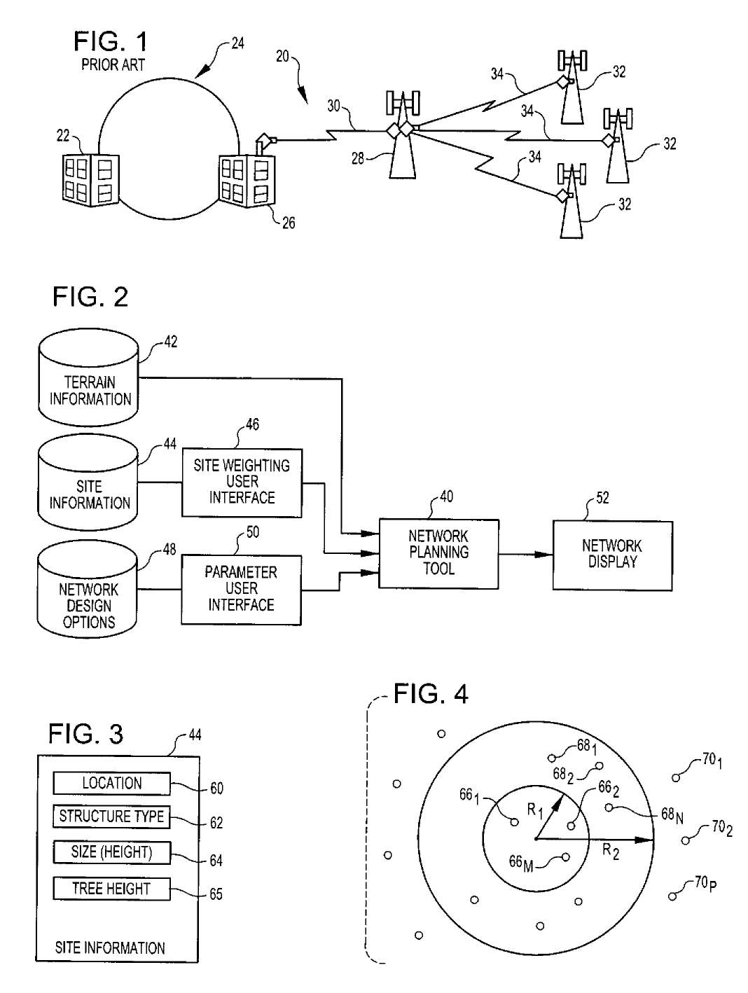

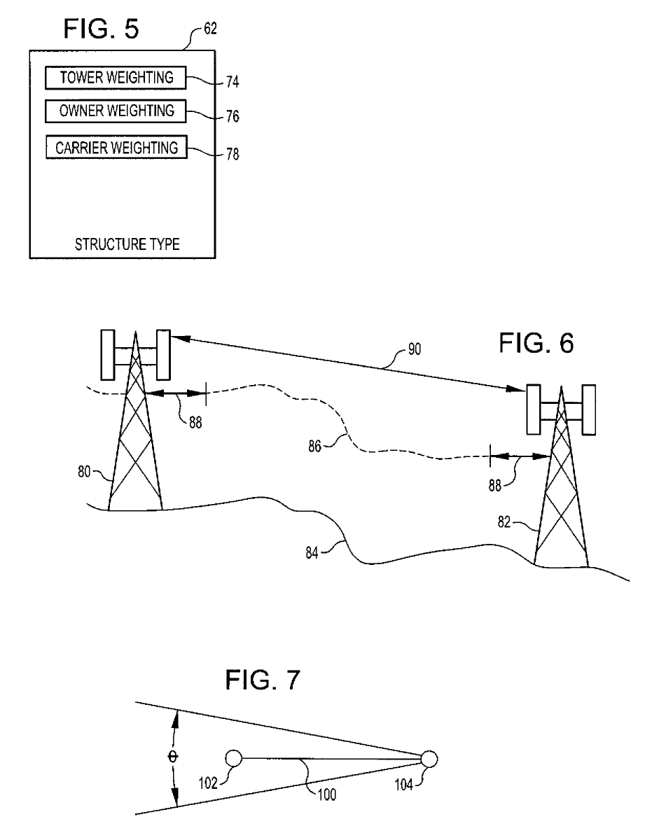

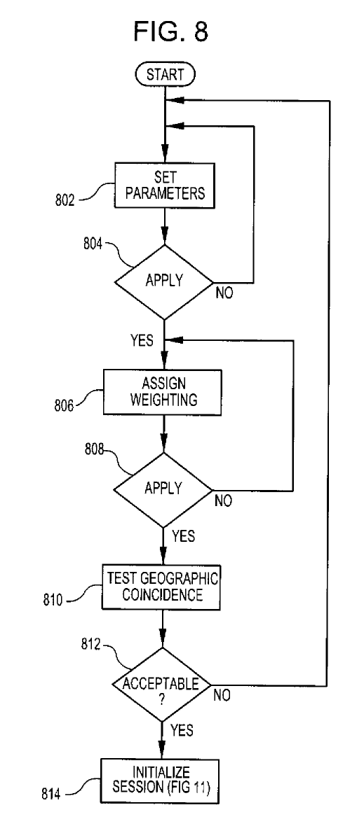

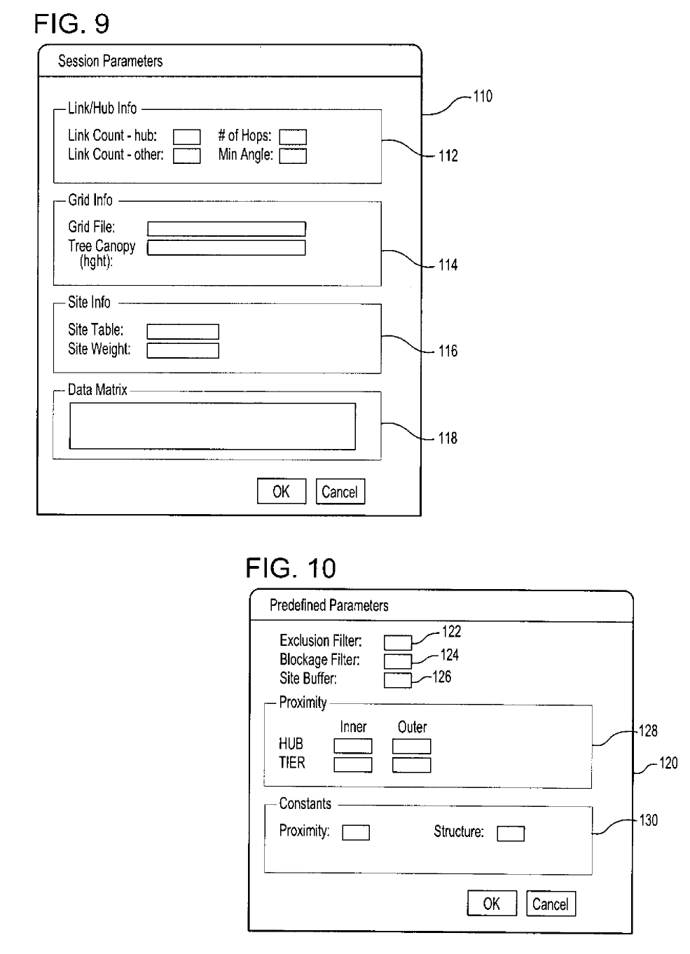

FIG. 8 shows a flow chart representing steps for preparing the microwave network planner tool 40 to initialize a session. Beginning at step 802, parameters for the session are set. These parameters may be set, for example, via user interfaces such as the user interfaces in FIGS. 9 and 10. In FIG. 9, a session parameters user interface 110 includes link/hub information 112. The link/hub information 112 includes link counts for the fiber network hub and other hubs in the system. These link counts represent the maximum number of links from the candidate fiber hub (e.g., similar to the fiber access point 26 in FIG. 1) to other microwave hubs, and the maximum number of links from other microwave hubs (e.g., similar to the sites 28 (second tier), 32 (third tier) in FIG. 1) to other sites, respectively. The number of hops represents the maximum number of hops in the design. Hops represent the number of links between two points. Thus a maximum number of hops would be the maximum number of links that are allowed between the candidate fiber network hub and the site most remote to the hub.

The minimum angle represents the minimum allowed angle between transmitters at the same location.

The session parameter user interface 110 also includes a section for grid information 114. This grid information includes a link or other information for accessing the terrain information 42. A tree canopy height assumption, such as the tree height assumption 86 described above, may also be entered at this location, if it is not already known for the area.

The session parameter user interface 110 also includes a site information box 116, providing a site table selector for selecting a database regarding the set of sites to use in a session. In addition, a site weight box is provided in which a user may select to use the site weighting information described with reference to FIG. 5. If the user selects to use site weighting information, then the user may be permitted to weight certain features, such as the tower, owner, or carrier features described with reference to FIG. 5. Other features may be weighted accordingly.

The sessions parameters user interface 100 also includes a data matrix box 118 that includes a matrix of available link distances for each of the sites based on frequency and capacity of the candidate sites. These distances are used for selecting candidate sites and assigning capacity and frequency values to the final design. The information may be publicly available, or may be maintained in a proprietary database maintained by a user.

A predefined parameters user interface 120 (FIG. 10) permits a user to provide other parameters for a session. As an example, the user may set an exclusion filter 122, which may represent the distance required between sites. In addition, a blockage filter 124 may be set which represents the angle ø in degrees described with reference to FIG. 7. A site buffer 126 may also be defined, which represents the site buffer 88 described with reference to FIG. 6.

A proximity box 128 may be provided for permitting weighting of proximity. For example, the inner and outer rings in the proximity box 128 may represent the radius R₁ and R₂ respectively. Hub and tier represent the fiber network connection site and other site in the network, respectively. A user may provide units for weighting in these boxes. For example, a user may provide double the weighting for an inner tier with respect to an outer tier.

A constants box 130 may be provided that allows weighting between proximity and site weighting for the final analysis of each site. In an embodiment, these two constants add up to one so that they represent a percentage of weighting of each factor, so that appropriate weighting may be allocated to site and proximity weighting selections. For example, if each is allocated 0.5, then the proximity and structure/site weighting are added together to provide a total number for each site. If a larger number is provided in the proximity data field, then heavier weighting is given to proximity, and vice versa.

As can be seen, the sessions parameters user interface 110 and the pre-defined parameters user interface 120 permit information to be submitted such as is described above with respect to the user interfaces 46 and 50. These user interfaces 110, 120 may be substituted with other selection devices for a user, may be combined into a single user interface, and/or may be distributed over multiple user interfaces.

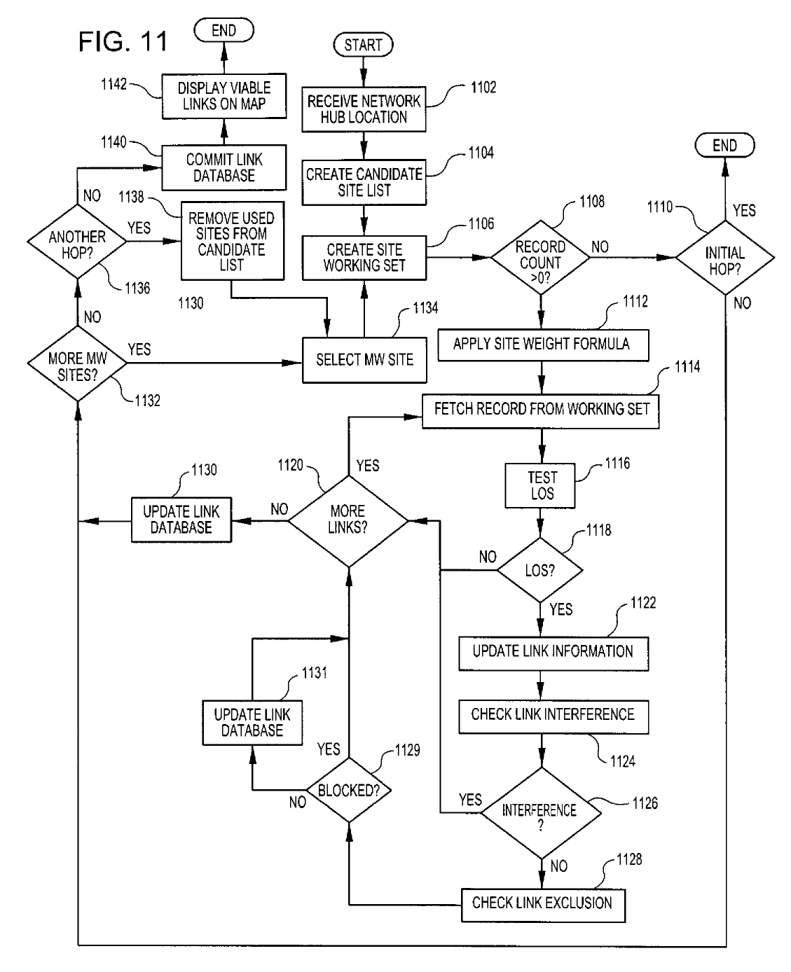

In any event, returning to FIG. 8, at step 804, a determination is made whether or not the parameters set in step 802 are appropriate. If not, the process loops back to step 802, perhaps with an error message. If so, then step 804 branches to step 806, where weighting is assigned, as defined above, with respect to the description of FIGS. 9 and 10. Again, at step 808, a determination is made whether the weighting was properly applied, and if not, step 808 branches back to step 806, perhaps with an error message. If so, then step 808 branches to step 810, where geographic coincidence is tested. That is, the grid file provided in the grid information box 114 is tested against the site table provided in the site information box 116 of the session parameters user interface 110. This test determines whether or not the two are describing terrain information and possible sites for the same area. A factor may be used, such as 90 percent, to allow some variation from an exact match. If the geographic coincidence does not match, then step 812 branches back to step 802, where the parameters are reset. If it is acceptable, then step 812 branches to step 814, where the session is initialized, and the process moves on to FIG. 11.

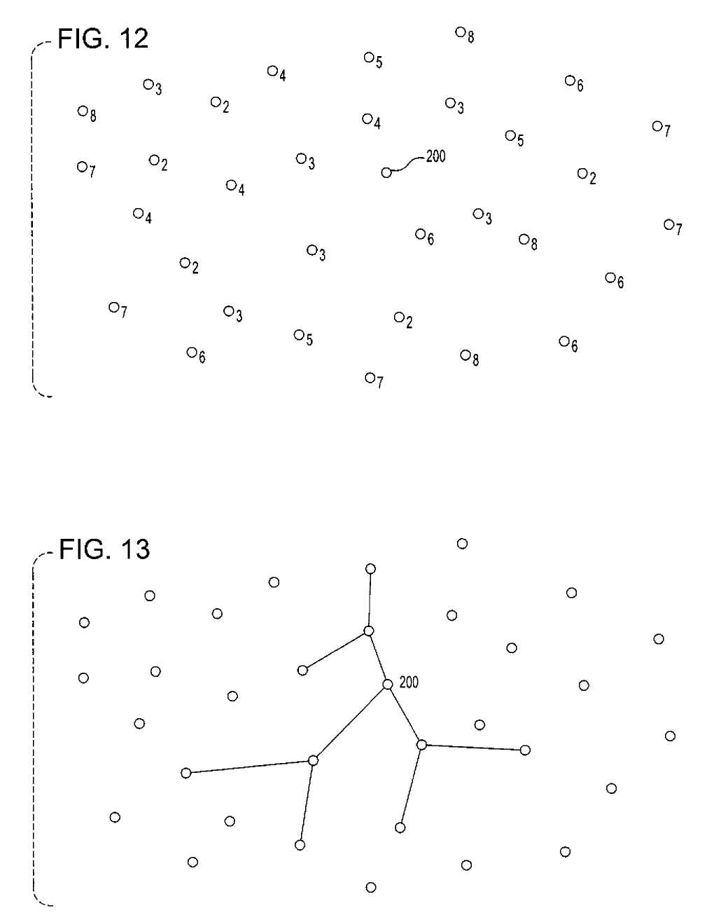

FIG. 11 shows steps for a session run by the microwave network planner tool 40 in accordance with an embodiment. Beginning at step 1102, the microwave network planner tool 40 receives a network hub location as selected by a user. As an example, as shown in FIG. 12, the network hub location 200 is selected. This network hub location is similar to the fiber access point 26 described with reference to FIG. 1. At step 1104, a candidate site list is created. This site list includes all available sites within the site information table selected above.

At step 1106, a site working set is created. This working set represents the number of sites that are suitable in capacity and frequency to connect to the network hub location. Capacity and frequency may vary according to the tier in the network being constructed. For an initial fiber hub site, such as the fiber access point 26 in FIG. 1, the capacity of the site is typically greater than in a second or third tier of the network, such as the sites 28, 32 in FIG. 1. In general, the evaluation of the fiber hub site is a first tier evaluation, and sites that are directly connected to the fiber hub site by microwave links are second tier sites. The capacity required at the second tier sites is typically less than the first tier sites. Likewise, capacity required at a third tier site may be less than a second tier site.

In any event, at the evaluation at each tier level, each of the sites found in step 1104 is evaluated to determine whether sufficient capacity and frequency is available to connect to the site. These sites include the fiber hub and the microwave hubs. This evaluation includes an evaluation of whether, at the desired capacity and frequency, if the site is a sufficient distance to connect to the hub being evaluated. If so, then the site is added to the working set in step 1106. If not, then the site is not added to the working set. Information regarding the capacity and frequency of the sites is available, for example, from the data matrix information box 118 described above.

At step 1108 a determination is made whether the record count is greater than 0. That is, a determination is made whether all possible sites have been evaluated. If the record count is equal to 0 and all sites have been evaluated, then step 1108 branches to step 1110, where a determination is made whether this is the initial hop. If so, then the process ends. If not, then the process branches to step 1132, described below. If the record count is greater than 0 in step 1108, then step 1108 branches to step 1112, where the site weight formula is applied. At this step, the site weighting is applied as described with respect to the constants box 130 described above.

Applying the site weight formula results in a set similar to FIG. 12. In this set, the network hub location 200 is surrounded by a large number of sites, each having a number assigned to the link. The numbers in FIG. 12 represent site weight information only, and the proximity information has yet to be applied. After proximity weighting is applied, then the numbers closer to the network hub location 200 will likely be higher. However, a combination of the two weightings may result in use of site that is not the most proximate site.

In an alternate implementation, the site weighting may be turned off, and only proximity weighting may be taken into account. In such an embodiment, the only factor in determining a site is its location. However, as described above, utilizing the site weighting information provides a more useful approach.

At step 1114, a record is fetched from the working set. In accordance with an embodiment, the record that is fetched first is the record having the highest point value from the site weight formula analysis performed in step 1112. In general, an analysis is performed in order from highest to lowest score provided by the site weight formula until a sufficient number of viable links are provided for the tier being analyzed. For example, if the analysis is being done for the fiber hub and the preferences for the network design state that there are to be three links for the fiber hub, then the microwave network planning tool 20 begins with the sites having the highest score from step 1112 and fetches those sites and analyzes them until viable links are provided. This analysis is performed for each tier of the microwave network, one site at a time, until a full network is produced.

After the first record is fetched in step 1114, the line of site is tested in step 1116 as described in FIG. 6. If there is not line of site, then step 1118 branches to step 1120, described below. If there is line of site, then step 1118 branches to step 1122, where the link information is updated. At step 1124, link interference is checked. This involves determining whether any sites are between the two sites and within the angle as described with FIG. 7 above. If so, step 1126 branches to step 1120. If not, then step 1126 branches to step 1128, where link exclusion is checked. This process involves evaluating the blockage filter 124, described above.

If the link is excluded, then step 1129 branches to step 1120. If not, step 1129 branches to step 1131, where the link database is updated to add a link to the site as a viable link. In either event, at step 1120, a determination is made whether there are more links to create, and if so, the process branches back to step 1114. If not, then the link database is updated at step 1130. If there are more microwave sites to be evaluated (e.g., additional sites to evaluate at the present tier), then step 1132 branches to step 1134, where an additional microwave site is selected, and the process proceeds back to step 1106. If there are not more microwave sites, then step 1132 branches to step 1136, where a determination is made whether there is another hop to be made. That is, whether similar evaluations need to be made at the sites that were just added.

If so, then the process branches from step 1136 to step 1138, where all used sites are removed from the candidate list, and the process proceeds to step 1134. If there is not another hop, then step 1136 branches to step 1140, where the link database is committed. The link database is then displayed on a map in step 1142.

An example of viable links from the map of FIG. 12 is shown in FIG. 13. After the viable links are displayed on a map, then an engineer may evaluate the links for actual use. This requires actually testing the links for actual line of site, capacity, and other issues.

The microwave network planner tool 40 provides a method and system by which a viable network may be provided within a short period of time. This system provides a major improvement over the existing iterative process and can substantially reduce time needed to develop a microwave network.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented method of designing a network including a plurality of wirelessly linked sites, comprising:
receiving information about network design constraints of the network, including fiber hub information about a fiber hub, the fiber hub information including a location;
accessing site information about a plurality of sites near the location;
receiving assigned preferences to factors associated with the plurality of sites;
creating a score for each of the plurality of sites based upon the assigned preferences; and
creating a network of linked sites utilizing the scores for the plurality of sites.

2. The method of claim 1, wherein the network design constraints further comprises:
the number of links for the fiber hub;
the number of tiers for the network; and
the number of links at each tier of the network.

3. The method of claim 1, wherein the factors associated with the plurality of sites includes, for each site, the cost of operating the site.

4. The method of claim 1, wherein the factors associated with the plurality of sites includes, for each site, possible revenue associated with the site.

5. The method of claim 1, wherein the factors associated with the plurality of sites includes, for each site, the proximity of the site to the fiber hub.

6. A computer-implemented method of designing a microwave network including a plurality of wirelessly linked sites, comprising:
receiving fiber hub information about a fiber hub for the network, the fiber hub information including:
a location of the fiber hub;
frequency, distance, and capacity requirements for forming a link the fiber hub;
a number of links for the fiber hub;
a number of tiers for the network;
a number of links at each tier of the network; and
frequency, distance, and capacity requirements for forming a link with a respective site at each of the tiers;
accessing site information about a plurality of sites near the location;
for the fiber hub:
(a) creating a working set of sites from the site information by evaluating the sites to determine if they meet the frequency, distance, and capacity requirements of the fiber hub;
(b) receiving assigned preferences to factors associated with the plurality of sites;
(c) creating a score for each of the plurality of sites in the working set based upon the assigned preferences;
(d) in an iterative process selected in order based upon the score of each of the sites in the working set, evaluating a site for forming a link with the fiber hub based upon meeting location requirements based upon at least one of (1) topography between the fiber hub and the site and (2) blockage or interference between the fiber hub and the site;
(e) if the location requirements are met, committing a link between the site and the fiber hub; and
(f) repeating acts (d) and (e) until the number of committed links equals the number of links for the fiber hub.

7. The method of claim 6, wherein each site used in a committed link with the fiber hub comprises a hub site, and further comprising:
for each hub site:
(a) creating a second working set of sites from the site information by evaluating the sites to determine if they meet the frequency, distance, and capacity requirements of the tier, the second working set eliminating hub sites;
(b) receiving assigned preferences to factors associated with the plurality of sites;
(c) creating a score for each of the plurality of sites in the second working set based upon the assigned preferences;
(d) in an iterative process selected in order based upon the score of each of the sites in the second working set, evaluating a site for forming a link with the hub site based upon meeting location requirements based upon at least one of (1) topography between the hub site and the site and (2) blockage or interference between the hub site and the site;
(e) if the location requirements are met, committing a link between the site and the fiber hub; and
(f) repeating acts (d) and (e) until the number of committed links equals the number of links for the tier.

8. The method of claim 6, wherein the factors associated with the plurality of sites includes, for each site, the cost of operating the site.

9. The method of claim 6, wherein the factors associated with the plurality of sites includes, for each site, possible revenue associated with the site.

10. The method of claim 6, wherein the factors associated with the plurality of sites includes, for each site, the proximity of the site to the fiber hub.

11. The method of claim 6, wherein meeting location requirements based upon topography between the fiber hub and the site comprises evaluating line of site between the fiber hub and the site.

12. The method of claim 11, wherein evaluating line of sight between the fiber hub and the site comprises:
accessing geographical information regarding topography between the fiber hub and the site;
projecting a hypothetical tree height between the fiber hub and the site and spaced upward from the topography; and
determining whether a line of sight between antenna positions for the fiber hub and the site extends above the hypothetical tree height.

13. The method of claim 6, wherein meeting location requirements based upon blockage between the fiber hub and the site comprises evaluating whether one or more sites are between the fiber hub and the site.

14. The method of claim 13, wherein evaluating whether one or more sites are between the fiber hub and the site comprises projecting a wedge having a defined angle from the fiber hub toward the site, with the site centered in the wedge, and evaluating if a site is located within the wedge and between the site and the fiber hub.

15. The method of claim 6, wherein meeting location requirements based upon interference between the fiber hub and the site comprises evaluating whether one or more sites are within a particular distance from the site.

16. The method of claim 6, wherein the factors associated with the plurality of sites includes only, for each site, the proximity of the site to the fiber hub.
